(19) United States
(12) Patent Application Publication
(10) Pub. No.: US 2006/0229089 A1
(43) Pub. Date: Oct. 12, 2006

(54) Method and apparatus for interference control in wireless communication systems

(76) Inventors: Yeliz Tokgoz, La Jolla, CA (US); Mingxi Fan, San Diego, CA (US); John E. Smee, San Diego, CA (US); Jilei Hou, Carlsbad, CA (US)

Correspondence Address: QUALCOMM INCORPORATED, 5775 MOREHOUSE DR., SAN DIEGO, CA, 92121, US

(21) Appl. No.: 11/102,134

(22) Filed: Apr. 7, 2005

(51) Int. Cl. H04B 7/005

(52) U.S. Cl. 455/501; 455/67.11

(57) ABSTRACT

Embodiments disclosed herein relate to providing effective interference control in a wireless communication system. In one embodiment, a method for determining an interference level in a wireless communication system is described, including: determining a rise-over-thermal (RoT) metric based on an RoT received at each receiver antenna of an access network, the RoT relating to a ratio of a total energy to a thermal energy received at each receiver antenna; determining an interference-reduction factor (ρ) in relation to an interference energy reduced from the total energy received at each receiver antenna; and determining an effective rise-over-thermal (RoT^{eff}) based on the RoT metric and the interference-reduction factor, the RoT^{eff} relating to the interference level in the wireless communication system. The method may further include comparing the RoT^{eff} with a threshold and relating the result of the comparison (e.g., the sector loading status) to each access terminal in communication with the access network.

### BACKGROUND

1. Field

This disclosure relates generally to wireless communications. More specifically, embodiments disclosed herein relate to methods and systems for providing effective interference control in wireless communications.

2. Background

Wireless communication systems are widely deployed to provide various types of communication (e.g., voice, data, etc.) to multiple users. Such systems may be based on code division multiple access (CDMA), time division multiple access (TDMA), frequency division multiple access (FDMA), or other multiple access techniques. CDMA systems offer some desirable features, including increased system capacity. A CDMA system may be designed to implement one or more standards, such as IS-95, cdma2000, IS-856, W-CDMA, TS-CDMA, and other standards.

As wireless communication systems strive to provide diverse services at ever higher data rates to a growing number of users (or subscribers), there lies a challenge to control the multi-user interference in a manner that ensures the quality of service and maintains a desired throughput.

### BRIEF DESCRIPTION OF THE DRAWINGS

FIG. 1 illustrates an embodiment of a wireless communication system capable of supporting multiple users;

FIG. 2 illustrates a flow diagram of a process which may be used in one embodiment to determine an interference level in a wireless communication system;

FIG. 3 illustrates a flow diagram of a process which may be used in another embodiment to determine an interference level in a wireless communication system;

FIG. 4 illustrates a flow diagram of a process which may be used in yet another embodiment to determine an interference level in a wireless communication system;

FIG. 5 illustrates a block diagram of one embodiment of an apparatus for wireless communications; and

FIG. 6 illustrates a block diagram of another embodiment of an apparatus for wireless communications.

### DETAILED DESCRIPTION

Embodiments disclosed herein relate to a wireless communication system, where multiple access terminals communicate with one or more access networks.

An access network (AN) described herein may refer to the network portion of a communication system, and may include (but not limited to) a base station (BS), a base station transceiver system (BTS), an access point (AP), a modem pool transceiver (MPT), a Node B (e.g., in a W-CDMA type system), etc.

An access terminal (AT) described herein may refer to various types of devices, including (but not limited to) a wired phone, a wireless phone, a cellular phone, a lap top computer, a wireless communication personal computer (PC) card, a personal digital assistant (PDA), an external or internal modem, etc. An AT may be any data device that communicates through a wireless channel or through a wired channel (e.g., by way of fiber optic or coaxial cables). An AT may have various names, such as access unit, subscriber unit, mobile station, mobile device, mobile unit, mobile phone, mobile, remote station, remote terminal, remote unit, user device, user equipment, handheld device, etc. Different ATs may be incorporated into a system. ATs may be mobile or stationary, and may be dispersed throughout a communication system. An AT may communicate with one or more ANs on a forward link and/or a reverse link at a given moment. The forward link (or downlink) refers to transmission from an AN to an AT. The reverse link (or uplink) refers to transmission from the AT to the AN.

The term “reduction” (or “reduced”) is herein construed to include cancellation (or canceled), subtraction (or subtracted), suppression (or suppressed), rejection (or rejected), and other similar or equivalent meanings. For simplicity and clarity, the term “sector” is used to refer a cell, or a section of a cell, serviced by an AN. Also for clarity and simplicity, the term “energy” is herein used in the appropriate context. (One skilled in the art will appreciate that energy measured per unit time (e.g., per second) constitutes a power.) Furthermore, irrespective of the specific name adopted for ease of description, the quantity termed “rise-over-thermal” (RoT) is construed generally and broadly herein to relate to a ratio of the total energy to the thermal energy, e.g., received at a receiver antenna. The term “loading status” is herein used in relation to the received interference energy relative to thermal energy (e.g., in a sector). As used herein, a “receiver antenna” may be an antenna capable of receiving, or an antenna capable of receiving and transmitting.

In a wireless (e.g., cellular) system, multiple ATs typically communicate with an AN simultaneously over a designated spectrum on the reverse link, thus interfering with one another at the receiver of the AN. Such multi-user (or multiple-access) interference may be a limiting factor to the system's capacity and throughput. For example, in some direct-sequence code division multiple access (DS-CDMA) systems, because the transmit waveforms of various ATs are non-orthogonal, each AT experiences both in-sector interference (e.g., interference from ATs within the same sector) and out-of-sector interference (e.g., interference from ATs outside the sector). In an orthogonal system, such as a time division multiple access (TDMA) or orthogonal frequency division multiple access (OFDMA) system, ATs may not experience significant in-sector interference, but nonetheless suffer from out-of-sector interference.

To maintain the quality of service and adequate coverage for all ATs within the network, an algorithm (or scheme) is used at the medium access control (MAC) layer to maintain the interference level experienced by each AT under a desirable “ceiling,” while allowing the network resources to be efficiently utilized. For example, the overall interference level received at the AN is typically controlled by limiting each AT's overall transmit power (and hence data rate). A common form of such MAC algorithm involves periodically estimating the interference level associated with a sector and comparing the estimated interference level with a desired threshold. If the estimated interference level is higher than the threshold, the sector is deemed “busy” (e.g., in terms of its loading status), and the sector loading status is related to ATs within the sector. The ATs may accordingly lower their transmit powers (hence data rates). For example, in a cdma2000 1xEV-DO type system, a reverse activity bit (RAB) is used on the forward link to relate (or feedback) the sector loading status to ATs within a sector. If the sector is “busy,” for example, the RAB is set to have a “busy” status (e.g., corresponding to “1”) and transmitted to the ATs. (See, e.g., the “cdma2000 High Rate Packet Data Air Interface Specification,” 3GPP2 C.S0024-A, Version 1, March 2004, promulgated by the consortium “3rd Generation Partnership Project 2.”)

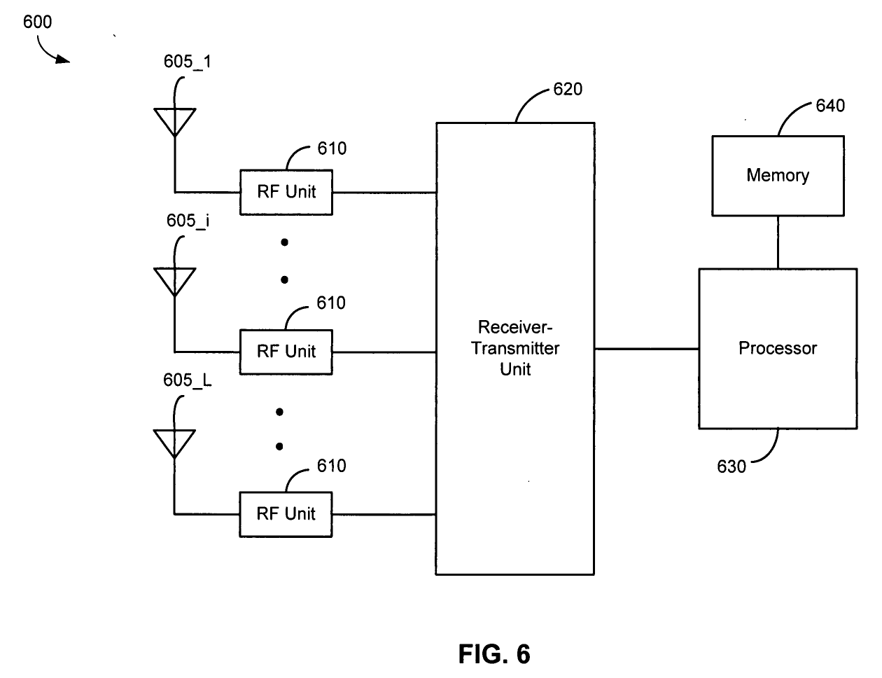

A challenge in designing an effective MAC algorithm is how to estimate the interference level that truly affects each AT's performance in a given sector. An interference metric that has been used in some systems is the rise-over-thermal (RoT), which is defined as the ratio of the total energy (Iₒ) to the thermal energy (Nₒ) received at a receiver antenna of the AN. For a system with multiple receiver antennas (e.g., see antennas 610 in FIG. 6 for an illustration), an RoT metric (RoT_metric) may be introduced based on the set of RoTs received by the individual receiver antennas. The policy for determining whether the sector is “busy” may be described as follows:

$$RoT\_metric = f ( {RoT}_{1} , … {RoT}_{i} , … {RoT}_{L} ) \begin{matrix}{Sector\_Busy}_{>} \\ {Sector\_Not \_Busy}^{<}\end{matrix} Threshold \qquad ( 1 )$$

where RoTᵢ denotes the RoT received at the ith receiver antenna, i denotes the “antenna index” (i=1, 2, . . . , L) herein, L denotes the total number of receiver antennas associated with the sector, and f(●) denotes a function of (RoT₁, . . . RoTᵢ, . . . . RoT_{L}). Examples of f(●) include:

1) Maximum of RoTs from all receiver antennas:

$${Max}_{1 \leq i \leq L} \{ {RoT}_{i} \} \begin{matrix}{Sector\_Busy}_{>} \\ {Sector\_Not \_Busy}^{<}\end{matrix} Threshold , i \text{:} antenna index \qquad ( 2 )$$

2) Mean of RoTs from all receiver antennas:

$$\frac{1}{L} {\sum }_{i = 1}^{L} {RoT}_{i} \begin{matrix}{Sector\_Busy}_{>} \\ {Sector\_Not \_Busy}^{<}\end{matrix} Threshold , i \text{:} antenna index \qquad ( 3 )$$

3) Harmonic mean of RoTs from all receiver antennas:

$$\frac{1}{\frac{1}{L} {\sum }_{i = 1}^{L} \frac{1}{{RoT}_{i}}} \begin{matrix}{Sector\_Busy}_{>} \\ {Sector\_Not \_Busy}^{<}\end{matrix} Threshold , i \text{:} antenna index \qquad ( 4 )$$

In a system with a large number of ATs (e.g., a DS-CDMA system with ATs transmitting at comparable rates and nearly perfect power control), for example, the RoT may approach the ratio of total interference energy experienced by the ATs to thermal noise energy, and hence become an effective measure of the multiple-access interference level. In an AN configured to implement interference cancellation or suppression (e.g., to remove or suppress some multiple-access interference) after the RoT measurement, however, an interference metric based on the measured RoT alone may significantly over-estimate the actual interference level experienced by the ATs and hence unduly limit the system capacity. In such situation, the RoT may be, at best, a reasonable estimate of the pre-cancellation interference level; the actual performance of the ATs, however, depends largely on the post-cancellation interference level.

A need therefore exists for effective interference control allowing efficient utilization of network resources and maximized throughput. Embodiments disclosed herein relate to providing effective interference control in wireless communication systems.

In one embodiment, a method for determining an interference level in a wireless communication system is provided. The method includes: determining an RoT metric based on an RoT received at each receiver antenna of an AN, the RoT relating to a ratio of a total energy to a thermal energy received at each receiver antenna; determining an interference-reduction factor (ρ) in relation to an interference energy reduced from the total energy received at each receiver antenna; and determining an effective rise-over-thermal (RoT^{eff}) based on the RoT metric and the interference-reduction factor, the RoT^{eff} relating to the interference level associated with the wireless communication system.

The method may further include comparing the RoT^{eff} with a threshold (e.g., to determine the corresponding loading status in the system). The method may also include relating the result of the comparison (e.g., the loading status thus determined) to each AT in communication with the AN. In one embodiment, for example, an RAB may be used to relate such information to each AT.

Various embodiments, features, and aspects are described in further detail below.

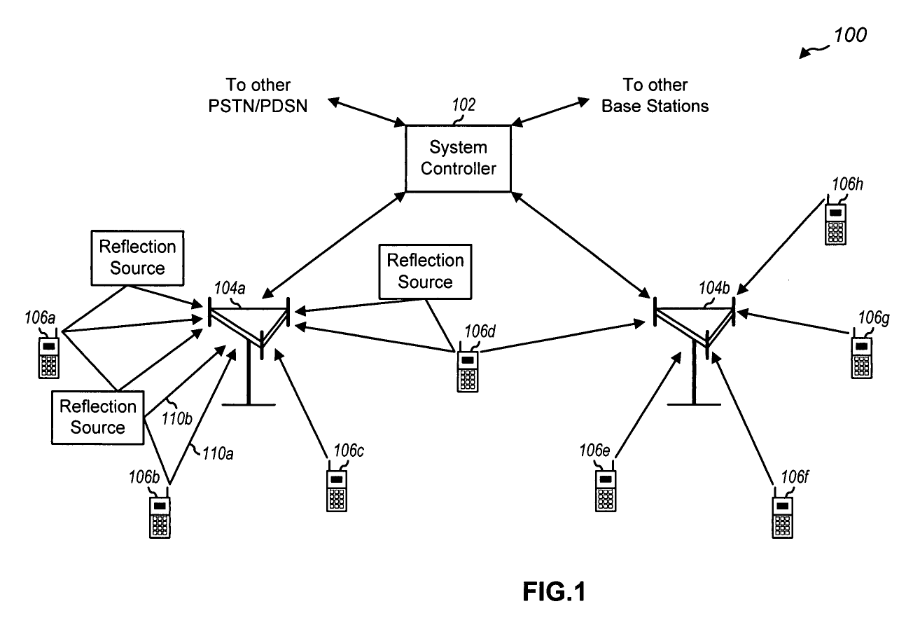

FIG. 1 shows a wireless communication system 100 configured to support a number of users, in which various disclosed embodiments and aspects may be implemented, as further described below. By way of example, system 100 provides communication for a number of cells, with each cell being serviced by a corresponding AN 104. Each cell may be further divided into one or more sectors. Various ATs 106, including ATs 106a-106h, are dispersed throughout the system. Each AT 106 may communicate with one or more ANs 104 (such as ANs 104a, 104b) on a forward link and/or a reverse link at a given moment, depending upon whether the AT is active and whether it is in soft handoff, for example.

In system 100, a system controller 102 (which may also be referred to as a base station controller (BSC)) is in communication with and serves to provide coordination and control for ANs 104. System controller 102 is further configured to control the routing of calls and/or data packets to ATs 106 via the corresponding ANs. System controller 102 may also be in communication with a public switched telephone network (PSTN) (e.g., via a mobile switching center, which is not explicitly show in FIG. 1), and with a packet data network (e.g., via a packet data serving node (PDSN), which is not explicitly shown in FIG. 1). In one embodiment, system 100 may be configured to support one or more CDMA standards, e.g., IS-95, cdma2000, IS-856, W-CDMA, TS-CDMA, some other spread-spectrum standards, or a combination thereof. These standards are known in the art.

A signal transmitted from an AT on the reverse link may reach an AN via one or more signal paths. These signal paths may include one or more straight parts (e.g., signal path 110a in FIG. 1) and reflected paths (e.g., signal path 110b in FIG. 1). A reflected path is created when the transmitted signal is reflected off a reflection source and arrives at the AN via a path different from the line-of-sight path. The reflection sources are typically artifacts in the environment in which the AT is operating (e.g., buildings, trees, other structures or “obstacles”). Owing to this multipath environment, the signal received at each receiver antenna of the AN may include a number of signal instances (or multipaths) from one or more ATs; each AT in communication with the AN may have multipath components at the receiver. For each multipath, signal energies from all other multipaths constitute interference at the receiver. Furthermore, signal energies associated with the pilot and overhead channels in all multipaths also act as interference to the data component in each multipath. In essence, each AT “sees” other ATs' signal energies as interference on the reverse link.

Some interference cancellation/reduction techniques have been devised, e.g., to cancel or reduce at least some of the interference energy from each multipath, so as to improve the signal quality of the data component in a desired multipath. For example, U.S. patent application Ser. Nos. 09/974,935 and 10/921,428, which are assigned to the same Assignee as this application, disclose methods and systems for estimating and canceling pilot-channel and data-channel interference in wireless communication systems. There are other spatial interference cancellation/reduction techniques.

In one embodiment, one or more ANs 104 in system 100 may be configured to implement an interference reduction scheme. In the presence of such interference reduction, the interference level and associated capacity loading should be assessed on a post-interference reduction basis. As a result, an effective RoT (RoT^{eff}) taking into account such effect may be used as a new interference metric. In one embodiment, RoT^{eff} is compared with a predetermined threshold, and a sector loading status may be determined based on the comparison. If RoT^{eff} exceeds the threshold, for example, the sector may be deemed “busy” and such “busy” status may be related (or feedback) to each AT in communication with the AN. Each AT may accordingly reduce its transmit power (and hence data rate) by an appropriate amount. If RoT^{eff} is below the threshold, the sector is deemed “not busy” and such “not busy” status may also be related to each AT in communication with the AN. As a result, the ATs may be allowed, for example, to maintain or increase their respective data rates. The situation may be summarized as follows:

$${RoT}^{eff} \begin{matrix}{Sector\_Busy}_{>} \\ {Sector\_Not \_Busy}^{<}\end{matrix} Threshold \qquad ( 5 )$$

Embodiments described below provide examples of RoT^{eff} in connection with some interference cancellation/reduction schemes.

Consider RoTₖ^{eff}, an interference metric for the kth AT (AT_k), where k denotes the “AT-index” herein. In this case, RoTₖ^{eff} may be defined as the ratio of the post-interference-reduction energy (N_{t,k}^{Post-IC}) to the thermal energy (Nₒ) associated with a single receiver antenna. RoTₖ^{eff} may be further expressed as:

$$\begin{matrix}\begin{matrix}{RoT}_{k}^{eff} = \frac{{N}_{t , k}^{Post - IC}}{{N}_{o}} \\ = \frac{{N}_{t , k}^{Post - IC}}{{I}_{o}} \cdot \frac{{I}_{o}}{{N}_{o}} \\ = \frac{{E}_{c , k} / {I}_{o}}{{( {E}_{c , k} / {N}_{t , k} )}_{Post - IC}} \cdot \frac{{I}_{o}}{{N}_{o}} \\ = {ρ}_{k} \cdot RoT\end{matrix} \\ where & ( 6 ) \\ {ρ}_{k} = \frac{{E}_{c , k} / {I}_{o}}{{( {E}_{c , k} / {N}_{t , k} )}_{Post - IC}} & ( 7 )\end{matrix}$$

In Eq. (6) above, RoT=Iₒ/Nₒ, as described above in connection with Eq. (1), and E_{c,k} is the energy associated with AT_k at the receiver. It follows from Eq. (6) that RoTₖ^{eff}, the interference metric for AT_k (or each AT), may be expressed as a scaling to RoT for a single receiver antenna system. The scaling factor ρₖ in Eq. (6) relates to the ratio of E_{c,k}/Iₒ to the post-interference-reduction signal-to-noise-plus-interference ratio (SINR) associated with AT_k, as shown in Eq. (7) above. Note that for a system with a large number of ATs (ATs), E_{c,k}/Iₒ approximates the pre-interference-reduction SINR.

Extending the above to a system with a plurality of receiver antennas, the overall interference metric for the system, RoT^{eff}, is given by

$${RoT}^{eff} = ρ f ( {RoT}_{1} , … {RoT}_{i} , … {RoT}_{L} ) \begin{matrix}{Sector\_Busy}_{>} \\ {Sector\_Not \_Busy}^{<}\end{matrix} Threshold \qquad ( 8 )$$

where RoTᵢ denotes the RoT received at the ith receiver antenna, i=1, 2, . . . , L, L being the total number of receiver antennas associated with the sector, and f(●) represents an RoT metric based on the set of RoTs received at the individual receiver antennas (some examples of f(●) are given in Eqs. (2)-(4) above). It follows from Eq. (8) that RoT^{eff} may be expressed as a scaling to the RoT metric for the sector. The scaling factor ρ in Eq. (8) relates to the interference energy that has been effectively reduced by the interference reduction scheme, hence termed “interference-reduction factor” herein. The determination of ρ may also depend on some specifics of the sector, as further described below.

In one embodiment, an AN may implement an interference-reduction scheme devised to estimate and cancel an interference energy associated with the pilot, overhead, and/or data channels from the total energy received at each receiver antenna, such as disclosed in U.S. patent application Ser. Nos. 09/974,935 and 10/921,428. A Rake receiver (as known in the art), working in conjunction with one or more receiver antennas of the AN, may be configured to facilitate such. The interference-reduction factor ρ in this case may be expressed as:

$$ρ = \frac{{I}_{o}^{eff}}{{I}_{o}} = \frac{{I}_{o} - {I}_{o}^{IC}}{{I}_{o}} \qquad ( 9 )$$

where Iₒ^{IC} denotes the amount of interference energy that has been canceled (or reduced) from the total energy Iₒ, and Iₒ^{eff} denotes the difference (termed “effective energy” herein). Substituting Eq. (9) into Eq. (8) above, RoT^{eff} is given by:

$$\begin{matrix}{RoT}^{eff} = ρ f ( {RoT}_{1} , … {RoT}_{i} , … {RoT}_{L} ) \\ = \frac{{I}_{o}^{eff}}{{I}_{o}} f ( {RoT}_{1} , … {RoT}_{i} , … {RoT}_{L} )\end{matrix} \qquad ( 10 )$$

In one embodiment, Iₒ^{IC} may include an amount of the pilot-channel energy that has been cancelled, and Iₒ^{eff} is given by

$${I}_{o}^{eff} = {I}_{o} - {\sum }_{j = 1}^{J} {β}_{pilot , j} {E}_{cp , j} \qquad ( 11 )$$

Substituting Eq. (11) into Eq. (9) above, it follows that

$$ρ = 1 - {\sum }_{j = 1}^{J} \frac{{E}_{cp , j}}{{I}_{o}} {β}_{pilot , j} \qquad ( 12 )$$

where J denotes the total number of active Rake fingers in the Rake receiver, E_{cp,j} denotes the estimated pilot energy collected by the jth Rake finger, and β_{pilot,j} denotes the fraction of E_{cp,j} that is cancelled, where 0≦β_{pilot,j}≦1. (Note, β_{pilot,j} is typically less than 1, due to channel estimation errors and other practical design constraints.)

In some embodiments, it may be desirable to obtain the interference-reduction factor ρ from a sequence of pre-interference-reduction sample measurements and a sequence of pre-interference-reduction sample measurements (e.g., in lieu of Eq. (12) above), as shown below:

$$ρ = \frac{{I}_{o}^{eff}}{{I}_{o}} = \frac{\frac{1}{M} {\sum }_{m = 0}^{M - 1} {\vert {x}^{′} [ D + m ] \vert}^{2}}{\frac{1}{N} {\sum }_{n = 0}^{N - 1} {\vert x [ D + n ] \vert}^{2}} \qquad ( 13 )$$

where x[n] and x′[n] denote the pre-interference-reduction and post-interference-reduction received samples, respectively, M and N denote sample average durations, and D denotes a delay parameter for a given received sample buffer.

For a system with a large number of ATs, Iₒ may approximate the total interference energy experienced by all in-sector ATs, and Iₒ^{eff} is Iₒ with at least some of the pilot interference energy from all in-sector ATs removed (such as shown in Eq. (11) above). The difference between Iₒ and Iₒ^{eff} thus constitutes the system gain. In such a system, the sector resources allocated to the pilot channels increase with the number of active in-sector ATs; and the interference experienced by in-sector ATs stems largely from the pilot channels. Thus, it may be desirable to implement a pilot interference cancellation/reduction scheme in a system with a large number of active ATs.

In one embodiment, Iₒ^{IC} in Eq. (9) above may include an amount of the data-channel energy that has been cancelled or reduced. The computation of Iₒ^{eff} in this case is similar to that associated with the pilot interference cancellation such as described above, and is given by

$${I}_{o}^{eff} = {I}_{o} - {\sum }_{j = 1}^{J} {β}_{data , j} {E}_{c d , j} = {I}_{o} - {\sum }_{j = 1}^{J} {β}_{data , j} T 2 {P}_{j} \cdot {E}_{cp , j} \qquad ( 14 )$$

where T2Pⱼ and β_{data,j} denote, respectively, the ratio of data-channel energy to pilot-channel energy and the fraction of the cancelled data-channel energy for the jth Rake finger, both of which may be obtained for example from the demodulation process. Substituting Eq. (14) into Eq. (9) above, the interference-reduction factor ρ is given by

$$ρ = 1 - {\sum }_{j = 1}^{J} \frac{{E}_{cp , j}}{{I}_{o}} \cdot {β}_{data , j} \cdot T 2 {P}_{j} \qquad ( 15 )$$

Note, in this case, the interference-reduction factor ρ may also be obtained from a sequence of pre-interference-reduction sample measurements and a sequence of post-interference-reduction sample measurements (such as shown in Eq. (13) above), in lieu of Eq. (15) above.

In some embodiments, Iₒ^{IC} in Eq. (9) above may include the cancelled pilot-channel energy as well as the cancelled data-channel energy. Combining Eqs. (12) and (15) above, it follows that the resulting interference-reduction factor ρ is given by

$$ρ = 1 - {\sum }_{j = 1}^{J} \frac{{E}_{cp , j}}{{I}_{o}} \cdot ( {β}_{data , j} \cdot T 2 {P}_{j} + {β}_{pilot , j} ) \qquad ( 16 )$$

The embodiments described above with respect to the pilot-channel and data-channel interference cancellations are provided by way of example, and should not be construed as limiting. In other embodiments, Eq. (16) above may be further extended to take into account additional cancelled interference energy, such as that associated with the overhead channels and/or other sources. Furthermore, Eqs. (9) and (10) above may generally be used with any interference-reduction scheme devised to reduce at least a fraction of the interference energy experienced by each in-sector AT and, therefore, reduce the “collective” rise-over-thermal across the sector. (Such scheme may be desirable, for example, in a situation where the interference experienced by in-sector ATs does not vary significantly.) Accordingly, the interference-reduction factor ρ is derived and applied on a per-sector basis. For example, the interference-reduction factor ρ may generally be obtained from a sequence of pre-interference-reduction sample measurements and a sequence of pre-interference-reduction sample measurements in accordance with a predetermined scheme, such as shown in Eq. (13) above.

In the events where the interference experienced by in-sector ATs varies substantially, it may be desirable to determine the interference-reduction factor ρ and RoT^{eff} on a per-AT basis, so as to maintain adequate coverage and quality of service for all in-sector ATs, as further described below.

In one embodiment, an AN may include a plurality of receiver antennas and is configured to implement a spatial interference reduction scheme, which may utilize for example a minimum-mean-square error (MMSE) combining technique. To ensure adequate coverage and service for all in-sector ATs, it may be effective to control the interference level based on the “worst-case” in-sector AT (e.g., a particular AT that experiences the most interference and benefits the least from the interference cancellation/reduction process), in a manner that maximizes system capacity. RoT^{eff} in this case may be expressed as:

$${RoT}^{eff} = {Max}_{0 < k \leq K} \{ \frac{{N}_{t , k}^{Post - IC}}{{N}_{o}} \} \begin{matrix}{Sector\_Busy}_{>} \\ {Sector\_Not \_Busy}^{<}\end{matrix} Threshold \qquad ( 17 )$$

where the AT-index k=1, 2, . . . . K (K being the total number of in-sector ATs), N_{t,k}^{Post-IC} denotes the total post-interference-reduction energy associated with AT_k, and Nₒ denotes the thermal energy. For a single receiver antenna system, it follows that

$$\begin{matrix}\frac{{N}_{t , k}^{Post - IC}}{{N}_{o}} = \frac{{N}_{t , k}^{Post - IC}}{{I}_{o}} \cdot \frac{{I}_{o}}{{N}_{o}} \\ = \frac{{E}_{c , k} / {I}_{o}}{{( {E}_{c , k} / {N}_{t , k} )}_{Post - IC}} \cdot \frac{{I}_{o}}{{N}_{o}} \\ = {ρ}_{k} \cdot RoT\end{matrix} \qquad ( 18 )$$

Extending Eq. (18) to a system with multiple receiver antennas, the right-hand side of Eq. (18) becomes:

$$\begin{matrix}{\tilde{ρ}}_{k} f ( {RoT}_{1} , … {RoT}_{i} , … {RoT}_{L} ) = \frac{{γ}_{{I}_{o} , . MMSE , k}}{{SINR}_{MMSE , k}} f ( {RoT}_{1} , … {RoT}_{i} , … {RoT}_{L} ) \\ where & ( 19 ) \\ {γ}_{{I}_{o} , MMSE , k} = \frac{{\underline{w}}_{k}^{H} {\underline{\underline{R}}}_{s , k} {\underline{w}}_{k}}{f ( {I}_{0.1} , {I}_{0.2} , … , {I}_{0 , L} ) \cdot {\underline{w}}_{k}^{H} \cdot {\underline{w}}_{k}} \\ and & ( 20 ) \\ {SINR}_{MMSE , k} = \frac{{\underline{w}}_{k}^{H} {\underline{\underline{R}}}_{s , k} {\underline{w}}_{k}}{{\underline{w}}_{k}^{H} {\underline{\underline{R}}}_{I + N , k} {\underline{w}}_{k}} & ( 21 )\end{matrix}$$

In the above, vector \overline{w}ₖ denotes the spatial MMSE combining weights (per AT_k) for the set of receiver antennas, matrix R_{I+N,k} denotes the correlation matrix of total interference-plus-thermal energy experienced by AT_k, and matrix R_{s,k} denotes the signal correlation matrix associated with AT_k. Iₒ is replaced by [wₖ^{H}(f(I_{0,1}, I_{0,2}, . . . , I_{0,L})·I)wₖ] when extending from a single receiver antenna to multiple ones, where I_{o,i} denotes the total energy received at the ith receiver antenna, and f(●) denotes a function (e.g., a maximum value, a mean value, a harmonic mean value, etc.) of its arguments, (I_{0,1}, I_{0,2}, . . . , I_{0,L}).

In Eq. (20), γ_{I}_{ₒ}_{,MMSE,k} denotes AT_k's SINR under the condition that the total interference energy has a correlation matrix given by f(I_{0,1}, I_{0,2}, . . . , I_{0,L})·I. In other words, γ_{I}_{ₒ}_{,MMSE,k} relates to the spatially uncorrelated interference with an energy equal to f(I_{0,1}, I_{0,2}, . . . , I_{0,L}), hence termed “uncorrelated-interference SINR” herein. SINR_{MMSE,k} denotes the post-MMSE-combining SINR of AT_k. It may be further shown that

$$\begin{matrix}{\tilde{ρ}}_{k} = \frac{{γ}_{{I}_{o} , MMSE , k}}{{SINR}_{MMSE , k}} \\ = \frac{{\underline{w}}_{k}^{H} {\underline{\underline{R}}}_{I + N , k} {\underline{w}}_{k}}{f ( {I}_{0.1} , {I}_{0.2} , … , {I}_{0 , L} ) \cdot {\underline{w}}_{k}^{H} \cdot {\underline{w}}_{k}} \\ = \frac{{\underline{w}}_{k}^{H} {\underline{\underline{R}}}_{I + N , k} {\underline{w}}_{k}}{f ( {I}_{0.1} , {I}_{0.2} , … , {I}_{0 , L} ) {‖ {\underline{w}}_{k} ‖}^{2}}\end{matrix} \qquad ( 22 )$$

As a result, Eq. (17) above may be further expressed as:

$${RoT}^{eff} = {Max}_{0 < k \leq K} \{ {\tilde{ρ}}_{k} \} \cdot f ( {RoT}_{1} , … {RoT}_{i} , … {RoT}_{L} ) \begin{matrix}{Sector\_Busy}_{>} \\ {Sector\_Not \_Busy}^{<}\end{matrix} Threshold \qquad ( 23 )$$

where \tilde{ρ}ₖ is given by Eq. (22) above,

$${MAX}_{0 < k \leq K} \{ {\tilde{ρ}}_{k} \}$$

denotes the largest \tilde{ρ}ₖ (or the largest ratio of γ_{I}_{ₒ}_{,MMSE,k} to SINR_{MMSE,k}) among the in-sector ATs.

In some embodiments, a maximum-rate-combining (MRC) technique may also be implemented. \tilde{ρ}ₖ may be alternatively determined based on a ratio of MRC SJR to MMSE SINR for AT_k (e.g., in lieu of using γ_{I}_{ₒ}_{,MMSE,k} above). Such may be desirable for example in the event where Iₒ undergoes rapid fluctuations. In one embodiment, RoT^{eff} may be expressed as:

$$\begin{matrix}{RoT}^{eff} = \tilde{ρ} \cdot f ( {RoT}_{1} , … {RoT}_{i} , … {RoT}_{L} ) \begin{matrix}{>}^{Sector\_Busy} \\ {<}_{Sector\_Not \_Busy}\end{matrix} Threshold \\ where & ( 24 ) \\ \tilde{ρ} = \frac{{SINR}_{MRC , q}}{{SINR}_{MMSE , q}} & ( 25 ) \\ {SINR}_{MRC , q} = \frac{{\underline{u}}_{q}^{H} {\underline{\underline{R}}}_{s , q} {\underline{u}}_{q}}{{\underline{u}}_{q}^{H} {\underline{\underline{R}}}_{I + N , q} {\underline{u}}_{q}} \\ and & ( 26 ) \\ q = {argmax}_{1 \leq k \leq K} ( \frac{{\underline{w}}_{k}^{H} {\underline{\underline{R}}}_{I + N , k} {\underline{w}}_{k}}{{‖ {\underline{w}}_{k} ‖}^{2}} ) & ( 27 )\end{matrix}$$

In the above, q in Eq. (27) denotes the AT-index for the “worst-case” in-sector AT, vector u_{q} in Eq. (26) denotes the spatial MRC combining weights associated with the qth AT (AT_q) for the set of receiver antennas, and SINR_{MMSE,q} is as shown in Eq. (21). In this case, q (hence the “worst-case” in-sector AT) is first selected based on Eq. (27), and the interference-reduction factor \tilde{ρ} is subsequently determined by substituting q in Eq. (25) above. Note, for a system with a large number of ATs, SINR_{MRC,k} may approximate γ_{I}_{ₒ}_{,MMSE,k}.

In some embodiments, the AN may be further configured to implement a temporal interference reduction scheme in conjunction with the spatial interference reduction scheme. In one embodiment, the temporal interference reduction scheme may be carried out first, e.g., to remove the pilot-channel, data-channel and/or other interference energies, such as described above. This leads to an Iₒ^{eff} that is less than the pre-interference-reduction Iₒ, as shown above. The spatial interference reduction scheme (such as described above) is then performed on the post-temporal-interference-reduction data samples on a per-AT basis. The resulting interference-reduction factor ρₖ^{ST} (per AT_k) may be expressed as follows:

$${ρ}_{k}^{ST} = \frac{{\underline{w}}_{k}^{H} {\underline{\underline{R}}}_{I + N , k} {\underline{w}}_{k}}{{I}_{o}^{eff} {‖ {\underline{w}}_{k} ‖}^{2}} \cdot \frac{{I}_{o}^{eff}}{{I}_{o}} = \frac{{\underline{w}}_{k}^{H} {\underline{\underline{R}}}_{I + N , k} {\underline{w}}_{k}}{{I}_{o} {‖ {\underline{w}}_{k} ‖}^{2}} \qquad ( 28 )$$

where the term Iₒ^{eff}/Iₒ takes into account the effect of the temporal interference reduction (e.g., see Eq. (9) above), and the term proceeding Iₒ^{eff}/Iₒ is due to the spatial interference reduction (e.g., see Eq. (22) above with f(I_{0,1}, I_{0,2}, . . . , I_{0,L}) being replaced by Iₒ^{eff}). The net result of Eq. (28) appears similar to Eq. (22) above, which may not be surprising, in light of that the computation of SINR_{MMSE,k} is based on the post-temporal-interference-reduction results. This is also to say that Eq. (23) above may be used in a system employing a combination of temporal and spatial interference reduction schemes.

Referring back to the embodiment associated with Eq. (24): because \tilde{ρ} involves a ratio of two SINRs, the effect of the temporal interference reduction may not be reflected. In this case, the “net” interference-reduction factor \tilde{ρ}^{ST} taking into account the effects of the temporal and spatial interference reduction may be obtained by combining Eqs. (13) and 24, as shown below:

$${\tilde{ρ}}^{ST} = \frac{{SINR}_{MRC , q}}{{SINR}_{MMSE , q}} \cdot \frac{{I}_{o}^{eff}}{{I}_{o}} = \frac{{SINR}_{MRC , q}}{{SINR}_{MMSE , q}} \cdot \frac{\frac{1}{M} {\sum }_{m = 0}^{M - 1} {\vert {x}^{′} [ D + m ] \vert}^{2}}{\frac{1}{N} {\sum }_{n = 0}^{N - 1} {\vert x [ D + n ] \vert}^{2}} \qquad ( 29 )$$

where q is as shown in Eq. (27) above, x[n] and x′[n] are the pre-temporal-interference-reduction and post-temporal-interference-reduction received samples, respectively, M and N denote sample average durations, and D denotes a delay parameter for a particular sample buffer. As a result, it follows that:

$${RoT}^{eff} = {\tilde{ρ}}^{ST} f ( {RoT}_{1} , … {RoT}_{i} , … {RoT}_{L} ) \begin{matrix}{>}^{Sector\_Busy} \\ {<}_{Sector\_Not \_Busy}\end{matrix} Threshold \qquad ( 30 )$$

In some embodiments, an “in-sector AT” described above may have the AN servicing the sector in its active set, and have the best reverse link with the AN. In one implementation, such in-sector ATs may be determined for example based on comparing the filtered long-term pilot SINR of an AT to the pilot setpoint of the power control algorithm employed in the system. If the received pilot SNR is below the setpoint by a predetermined amount, for example, it may be assumed that the AT is power-controlled and hence served by another sector, thus not an in-sector AT. It will be appreciated that there are other ways to determine the in-sector ATs and implement various disclosed embodiments.

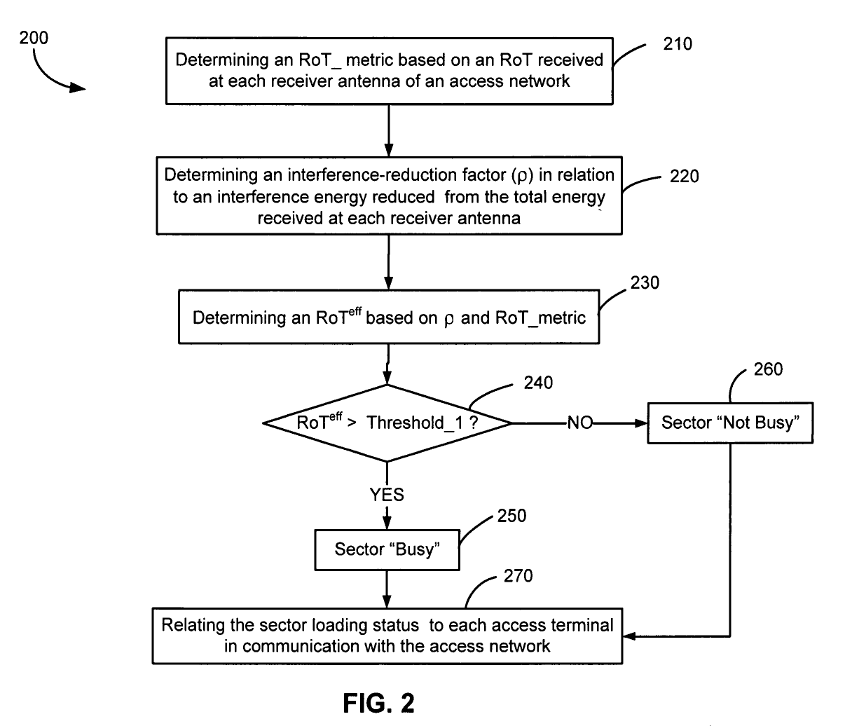

FIG. 2 shows a flow diagram of a process 200, which may be used in one embodiment to determine an interference level in a wireless communication system. Step 210 determines an RoT_metric based on an RoT received at each receiver antenna of an AN, where the RoT relates to a ratio of a total energy to a thermal energy received at each receiver antenna. Step 220 determines an interference-reduction factor (ρ) in relation to an interference energy reduced from the total energy received at each receiver antenna. Step 230 determines an RoT^{eff} based on ρ and RoT_metric, where RoT^{eff} relates to the interference level in the system. In one embodiment, RoT^{eff} may be determined, for example, based on a product of ρ and RoT_metric (such as described above). Examples of the interference-reduction factor ρ in connection with some interference-reduction schemes are described above.

Process 200 may further include comparing RoT^{eff} with a first threshold (Threshold_1), as recited in step 240. If RoT^{eff} is greater than Threshold_1 (as indicated by the “YES” outcome), the sector is deemed “busy,” as shown in step 250. If RoT^{eff} is less than Threshold_1 (as indicated by the “NO” outcome), the sector is deemed “not busy,” as shown in step 260. Step 270 relates the sector loading status as determined in step 250 or 260 to each AT in communication with the AN. In one embodiment, step 270 may further include setting a corresponding status for an RAB to be transmitted to each AT. For example, if RoT^{eff} is greater than Threshold_1, the RAB may be set to “1”, corresponding to the sector loading status being “busy”. Otherwise, the RAB may be set to be “0”, corresponding to the sector loading status being “not busy.”

In a situation where the interference-reduction scheme implemented is effective in mostly reducing the in-sector interference, additional consideration may be given when assessing whether a sector is busy (or over-loaded). For example, there may be loading imbalance among different sectors, hence giving rise to the sectors having different degrees of tolerance to excessive (or additional) interference from other sectors. Further, if the RoT in a given sector is considerably high, a new accesss terminal may be blocked from accessing the sector. To avoid such situations and to achieve the overall system stability, a secondary condition may be imposed, in addition to the first condition involving RoT^{eff} as described above, when assessing whether a sector is busy. In one embodiment, if RoT^{eff} is less than the first threshold, a maximum RoT (RoT^{Max}) selected from the RoTs received at one or more receiver antennas in the sector is then compared with an upper (or second) threshold (Threshold_2), as given by Eq. (31) below:

$${RoT}^{Max} = {Max}_{0 < i \leq L} {\{ \frac{{I}_{o}}{{N}_{o}} \}}_{i} \begin{matrix}{>}^{Sector\_Busy} \\ {<}_{Sector\_Not \_Busy}\end{matrix} Threshold\_ 2 \qquad ( 31 )$$

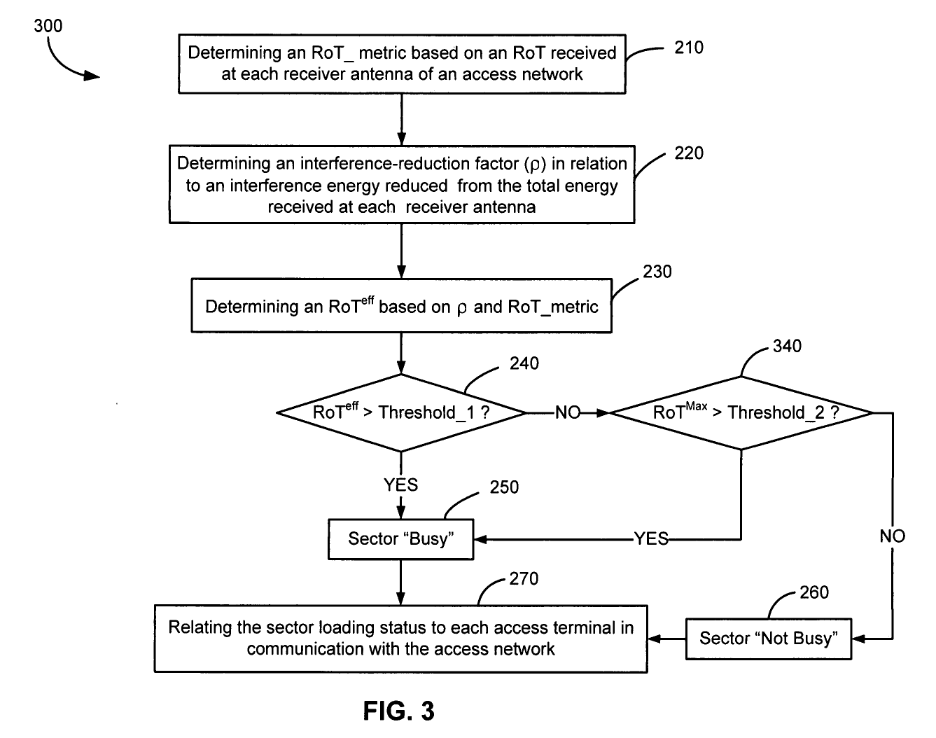

If RoT^{Max} is greater than Threshold_2, for example, the sector is deemed “busy,” as further described in FIG. 3 below.

FIG. 3 shows a flow diagram of a process 300, which may be used in another embodiment to determine an interference level in a wireless communication system. For illustration and clarity, process 300 may be built on process 200 of FIG. 2, hence like elements/steps are labeled with like numerals. In this case, if step 240 determines that RoT^{eff} is less than Threshold_1 (as indicated by the “NO” outcome), step 340 follows and compares an RoT^{Max} received at a particular receiver antenna with Threshold_2. If RoT^{Max} is greater than Threshold_2 (as indicated by the “YES” outcome), the sector is deemed “busy,” as shown in step 250. If RoT^{Max} is lessr than Threshold_2 (as indicated by the “NO” outcome), the sector is deemed “not busy,” as shown in step 260. As in the embodiment of FIG. 2, step 270 relates the sector loading status as determined in either scenario to each AT in communication with the AN. In one embodiment, step 270 may further include setting a corresponding status for an RAB to be transmitted to each AT, such as described above.

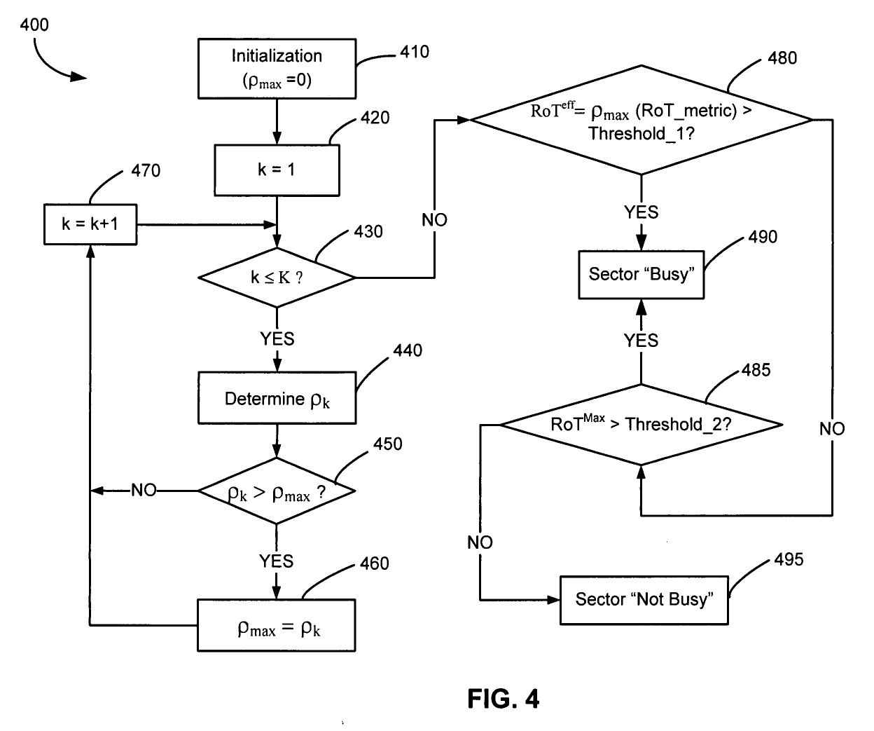

FIG. 4 depicts a flow diagram of a process 400, which may be used in yet another embodiment to determine an interference level in a wireless communication system (e.g., in a situation where RoT^{eff} is determined on a per-AT basis). Step 410 performs an initiation procedure (which may include setting the maximum value of the interference-reduction factor, ρ_{Max}, among the in-sector ATs to be zero). Step 420 selects an AT and sets the AT-index k to be k=1. Step 430 then checks if k≦K, where K is the total number of in-sector ATs. If the outcome of step 430 is “YES,” step 440 follows and determines the interference-reduction factor ρₖ for AT_k. Subsequently, step 450 checks if ρₖ>ρ_{Max}. If the outcome of step 450 is “YES,” step 460 follows and sets ρ_{Max}=ρₖ. Process 400 then proceeds to increment the AT-index k by 1 (k=k+1), as shown in step 470, and returns to step 430. If the outcome of step 450 is “NO,” process 400 also proceeds to increment the AT-index k by 1 (k=k+1) and returns to step 430.

In the embodiment of FIG. 4, if the outcome of step 430 is “NO,” step 480 follows and determines if RoT^{eff}, e.g., given by RoT^{eff}=ρ_{Max} (RoT_metric), is greater than Threshold_1. If the outcome of step 480 is “YES,” the sector is deemed “busy,” as shown in step 490. If the outcome of step 480 is “NO,” step 485 follows and determines if RoT^{Max} is greater than Threshold_2. If the outcome of step 485 is “YES,” the sector is deemed “busy,” as shown in step 490 follows. If the outcome of step 485 is “NO,” the sector is deemed “not busy,” as shown in step 495. In either scenario, the sector loading status as determined may be related to each AT in communication with the AN, such as described above with respect to the embodiment of FIG. 2 or 3.

It will be appreciated that there are other implementations of RoT^{eff} (and sector loading status) determination.

Various aspects and embodiments as disclosed herein may be implemented in hardware, software, firmware, or a combination thereof.

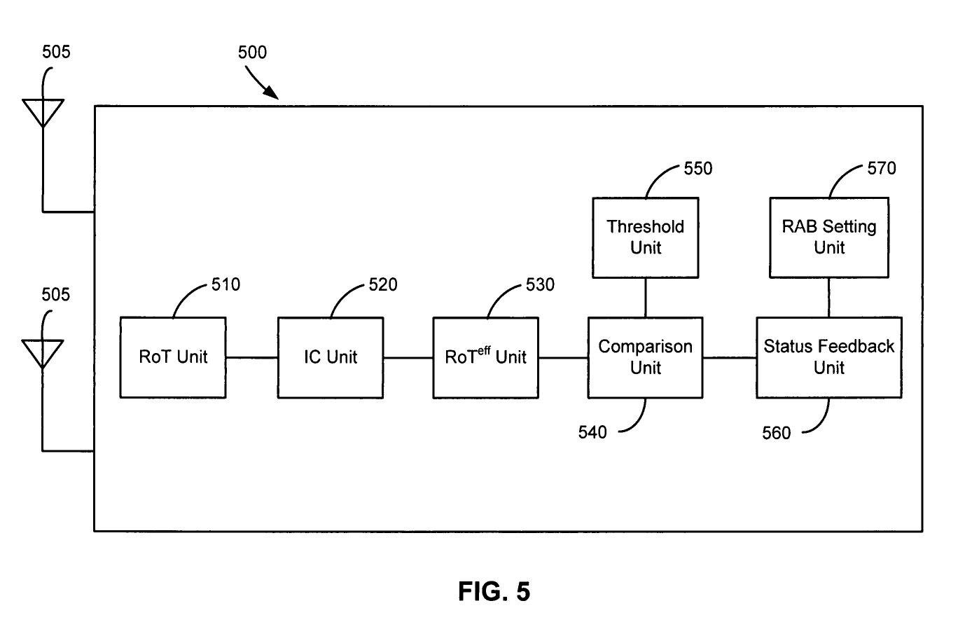

FIG. 5 shows a block diagram of an apparatus 500, in which various disclosed embodiments (such as described above) may be implemented. By way of example, apparatus 500 may include an RoT unit (or module) 510 configured to determine an RoT received at each antenna 505; an IC unit 520 configured to estimate and reduce at least some of the interference energy from the total energy received at each antenna 505; and an RoT^{eff} unit 530 configured to determine an RoT_metric based on the RoTs from RoT unit 510, an interference-reduction factor (ρ) in relation to the interference energy reduced by the IC unit 420, and an RoT^{eff} based on ρ and RoT_metric thus determined. Apparatus 500 may further include a comparison unit 540 configured to compare RoT^{eff} from RoT^{eff} unit 530 with a predetermined threshold, which may be provided by a threshold unit 550. In one embodiment, the comparison unit 540 may further determine a sector loading status based on the comparison. Apparatus 500 may also include a status feedback unit 560 configured to relate the result from comparison unit 540 (e.g., the sector loading status) to ATs in a sector. In one embodiment, status feedback unit 560 may include and/or implement the functions of an RAB setting unit 570 configured to set a corresponding status for an RAB to be transmitted to the ATs (e.g., by way of one or more antennas 505). Note, for simplicity and illustration, only two antennas are explicitly shown in FIG. 5, and each may be capable of receiving and transmitting. There may be any number of antennas in the system. There may also be separate receiver and transmitter antennas.

FIG. 6 shows a block diagram of an apparatus 600, which may also be used to implements some disclosed embodiments (such as described above). By way of example, apparatus 600 includes one or more antennas 605, such as antennas 605_1, 605_i, . . . 605_L; one or more RF units 610; a receiver-transmitter unit 620; and a processor 630. Apparatus 600 may further include a memory 640, in communication with processor 630. (As in the embodiment of FIG. 5, for simplicity and illustration, antennas 605 may each be capable of receiving and transmitting. In other embodiments, there may also be separate receiver and transmitter antennas.)

In apparatus 600, RF units 610 may be configured to perform various desired functions on the RF signals received at antennas 605, including (but not limited to) down-conversion (e.g., from RF to baseband), filtering, amplification, determining RoT, etc. In one embodiment, RF units 610 may incorporate and/or implement the functions of RoT unit 510 of FIG. 5. The outputs of RF units 610 (e.g., digital baseband samples) are provided to receiver-transmitter unit 620. Receiver-transmitter unit 620 may be configured to perform various desired functions on the received samples, including (but not limited to) time tracking, frequency tracking, dispreading (e.g., CDMA signals), demodulation, decoding, interference cancellation/reduction, etc. In one embodiment, receiver-transmitter unit 620 may incorporate and/or implement the functions of IC unit 520 of FIG. 5. Receiver-transmitter 620 may also include a Rake receiver configured to combine the received signals from antennas 605 and Rake fingers by way of appropriate combining techniques (e.g. MMSE and/or MRC techniques). Receiver-transmitter unit 620 may also be configured to perform various desired functions on the signals to be transmitted by one or more antennas 605, including (but not limited to) encoding, modulation, RAB setting, etc. (In some embodiments, a modem may be used to implement receiver-transmitter unit 620.) Processor 630 may be configured to determine an RoT_metric based the RoTs from RF units 610, an interference-reduction factor (ρ) in relation to the interference energy reduced at receiver-transmitter unit 620, and an RoT^{eff} based on RoT_metric and ρ. Processor 630 may also be configured to compare RoT^{eff} with a predetermined threshold, and determine for example a sector loading status based on the comparison. Processor 630 may be further configured to relate the result of the comparison (e.g., the sector loading status thus determined) to ATs in a sector, e.g., by setting a corresponding status for an RAB to be transmitted to the ATs. In one embodiment, processor 630 may be configured to incorporate and/or implement the functions of RoT^{eff} unit 530, comparison unit 540, threshold unit 550, status feedback unit 560, and RAB setting unit 570 of FIG. 5. Memory 6450 may embody instructions to be executed by processor 630 to carry out various functions.

Various units/modules in FIGS. 5-6 and other embodiments may be implemented in hardware, software, firmware, or a combination thereof. In a hardware implementation, various units may be implemented within one or more application specific integrated circuits (ASIC), digital signal processors (DSP), digital signal processing devices (DSPDs), field programmable gate arrays (FPGA), processors, microprocessors, controllers, microcontrollers, programmable logic devices (PLD), other electronic units, or any combination thereof. In a software implementation, various units may be implemented with modules (e.g., procedures, functions, and so on) that perform the functions described herein. The software codes may be stored in a memory unit (e.g., memory 640) and executed by a processor (e.g., processor 630). The memory unit may be implemented within the processor or external to the processor, in which case it can be communicatively coupled to the processor via various means known in the art.

Various disclosed embodiments may be implemented in an AN, and other wireless communication systems or devices to provide effective estimation and control of the interference level in the system.

In the above, RAB is used as one example of means or mechanisms to relate (or feedback) the secor loading status (e.g., as determined by RoT^{eff} described above) to ATs in a sector. There are other mechanisms to accomplish such. Further, RoT^{eff} as deescribed herein may be used in a varity of applications as an effective measure of multiple-access interference level in wireless communications.

The steps of a method or algorithm described in connection with the embodiments disclosed herein may be embodied directly in hardware, in a software module executed by a processor, or in a combination of the two. A software module may reside in Random Access Memory (RAM), flash memory, Read-only-Memory (ROM), Electrically Programmable ROM (EPROM), Electrically Erasable Programmable ROM (EEPROM), registers, hard disk, a removable disk, a CD-ROM, or any other form of storage medium known in the art. A storage medium is coupled to the processor such that the processor may read information from, and write information to, the storage medium. In the alternative, the storage medium may be integral to the processor. The processor and the storage medium may reside in an ASIC. The ASIC may reside in an AT. In the alternative, the processor and the storage medium may reside as discrete components in an AT.

The various illustrative logical blocks, modules, and circuits described in connection with the embodiments disclosed herein may be implemented or performed with a general purpose processor; a digital signal processor (DSP); an application specific integrated circuit (ASIC); a field programmable gate array (FPGA), or other programmable logic device; discrete gate or transistor logic; discrete hardware components, or any combination thereof designed to perform the functions described herein. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation outcomes should not be interpreted as causing a departure from the scope of the present invention.

The previous description of the disclosed embodiments is provided to enable any person skilled in the art to make or use the present invention. Various modifications to these embodiments will be apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus adapted for wire communications, comprising:
a processor configured to:
determine a rise-over-thermal (RoT) metric based on a rise-over-thermal received at each receiver antenna of an access network, the rise-over-thermal relating to a ratio of a total energy to a thermal energy received at each receiver antenna;
determine an interference-reduction factor in relation to an interference energy reduced from the total energy received at each receiver antenna; and
determine an effective rise-over-thermal (RoT^{eff}) based on the rise-over-thermal metric and the interference-reduction factor, the effective rise-over-thermal relating to an interference level in a wireless communication system.

2. The apparatus of claim 1, wherein the processor is further configured to compare the effective rise-over-thermal with a first threshold.

3. The apparatus of claim 2, wherein the processor is further configured to relate a result of the comparison to each access terminal in communication with the access network.

4. The apparatus of claim 3, wherein the relating includes setting a corresponding status for a reverse activity bit (RAB) to be transmitted to each access terminal.

5. The apparatus of claim 2, wherein the processor is further configured to determine a loading status associated with the wireless communication system, based on the result of the comparison.

6. The apparatus of claim 2, wherein the processor is further configured to compare a maximum rise-over-thermal received at a particular receiver antenna of the access network with a second threshold, if the effective rise-over-thermal is less than the first threshold, and to relate a result of the comparison to each access terminal in communication with the access network.

7. The apparatus of claim 6, wherein the relating includes setting a corresponding status for a reverse activity bit to be transmitted to each access terminal.

8. The apparatus of claim 1, wherein the effective rise-over-thermal is proportional to a product of the interference-reduction factor and the rise-over-thermal metric.

9. The apparatus of claim 1, wherein the interference-reduction factor is determined based on a sequence of pre-interference-reduction sample measurements and a sequence of post-interference-reduction sample measurements in accordance with a predetermined scheme.

10. The apparatus of claim 1, wherein the interference energy reduced includes an energy associated with at least one of a pilot channel, a data channel, and an overhead channel transmitted from each access terminal in communication with the access network.

11. The apparatus of claim 1, wherein the access network includes a plurality of receiver antennas and is configured to implement a spatial interference reduction scheme, the processor further configured to determine a signal-to-noise-plus-interference ratio (SINR) associated with each access terminal in communication with the access network.

12. The apparatus of claim 11, wherein the spatial interference reduction scheme includes a minimum-mean-square-error (MMSE) combining technique, the processor further configured to compute a ratio of an uncorrelated-interference SINR, γ_{I}_{ₒ}_{,MMSE}, and a post-MMSE SINR, SINR_{MMSE}, for each access terminal in communication with the access network, the interference-reduction factor being associated with the largest ratio of γ_{I}_{ₒ}_{,MMSE} to SINR_{MMSE} among one or more access terminals in communication with the access network.

13. The apparatus of claim 11, wherein the spatial interference reduction scheme includes a minimum-mean-square-error (MMSE) combining technique and a maximum-rate combining (MRC) technique, the processor further configured to compute a ratio of a signal-to-noise-plus-interference ratio determined by the MRC technique, SINR_{MRC}, and a signal-to-noise-plus-interference ratio determined by the MMSE technique SINR_{MMSE}, for each access terminal in communication with the access network, the interference-reduction factor being associated with the largest ratio of SINR_{MRC} to SINR_{MMSE} among one or more access terminals in communication with the access network.

14. The apparatus of claim 13, wherein the access network is further configured to implement a temporal interference reduction scheme in conjunction with the spatial interference reduction scheme, the professor further configured to determine the interference-reduction factor based on the largest ratio of SINR_{MRC} to SINR_{MMSE}, along with a sequence of pre-interference-reduction sample measurements and a sequence of post-interference-reduction sample measurements in accordance with the temporal interference reduction scheme.

15. A computer readable medium embodying instructions executable by a processor to:
determine a rise-over-thermal metric based on a rise-over-thermal received at each receiver antenna of an access network, the rise-over-thermal relating to a ratio of a total energy to a thermal energy received at each receiver antenna;
determine an interference-reduction factor in relation to an interference energy reduced from the total energy received at each receiver antenna; and
determine an effective rise-over-thermal based on the rise-over-thermal metric and the interference-reduction factor, the effective rise-over-thermal relating to an interference level in a wireless communication system.

16. The computer readable medium of claim 15, further comprising instructions to compare the effective rise-over-thermal with a first threshold.

17. The computer readable medium of claim 16, further comprising instructions to relate a result of the comparison to each access terminal in communication with the access network.

18. The computer readable medium of claim 17, wherein the relating includes setting a corresponding status for a reverse activity bit to be transmitted to each access terminal.

19. The computer readable medium of claim 16, further comprising instructions to determine a loading status associated with the wireless communication system, based on the result of the comparison.

20. The computer readable medium of claim 16, further comprising instructions to compare a maximum rise-over-thermal received at a particular receiver antenna of the access network with a second threshold, if the effective rise-over-thermal is less than the first threshold, and to relate a result of the comparison to each access terminal in communication with the access network.

21. The computer readable medium of claim 15, wherein the interference-reduction factor is determined based on a sequence of pre-interference-reduction sample measurements and a sequence of post-interference-reduction sample measurements in accordance with a predetermined scheme.

22. The computer readable medium of claim 15, wherein the interference energy reduced includes an energy associated with at least one of a pilot channel, a data channel, and an overhead channel transmitted from each access terminal in communication with the access network.

23. The computer readable medium of claim 15, wherein the access network includes a plurality of receiver antennas and is configured to implement a spatial interference reduction scheme, the computer readable medium further comprises instructions to determine a signal-to-noise-plus-interference ratio associated with each access terminal in communication with the access network.

24. The computer readable medium of claim 23, wherein the access network is further configured to implement a temporal interference reduction scheme in conjunction with the spatial interference reduction scheme, and wherein the computer readable medium further comprises instructions to determine the interference-reduction factor based in part on a sequence of pre-interference-reduction sample measurements and a sequence of post-interference-reduction sample measurements in accordance with the temporal interference reduction scheme.

25. An access network in a wireless communication system, comprising:
at least one receiver antenna; and
a processor configured to:
determine a rise-over-thermal metric based on a rise-over-thermal received at each receiver antenna, the rise-over-thermal relating to a ratio of a total energy to a thermal energy received at each receiver antenna;
determine an interference-reduction factor in relation to an interference energy reduced from the total energy received at each receiver antenna; and
determine an effective rise-over-thermal based on the rise-over-thermal metric and the interference-reduction factor, the effective rise-over-thermal relating to an interference level in the wireless communication system.

26. The access network of claim 25, wherein the processor is further configured to compare the effective rise-over-thermal with a first threshold and relate a result of the comparison to each access terminal in communication with the access network.

27. The access network of claim 26, wherein the relating includes setting a corresponding status for a reverse activity bit to be transmitted to each access terminal.

28. The access network of claim 26, wherein the processor is further configured to determine a loading status associated with the wireless communication system, based on the result of the comparison.

29. The access network of claim 26, wherein the processor is further configured to compare a maximum rise-over-thermal received at a particular receiver antenna of the access network with a second threshold, if the effective rise-over-thermal is less than the first threshold, and to relate a result of the comparison to each access terminal in communication with the access network.

30. The access network of claim 25, wherein the interference-reduction factor is determined based on a sequence of pre-interference-reduction sample measurements and a sequence of post-interference-reduction sample measurements in accordance with a predetermined scheme.

31. The access network of claim 25, wherein the interference energy reduced includes an energy associated with at least one of a pilot channel, a data channel, and an overhead channel transmitted from each access terminal in communication with the access network.

32. The access network of claim 25, wherein the access network includes a plurality of receiver antennas and is configured to implement a spatial interference reduction scheme, the processor further configured to determine a signal-to-noise-plus-interference ratio associated with each access terminal in communication with the access network.

33. The access network of claim 32, wherein the access network is further configured to implement a temporal interference reduction scheme in conjunction with the spatial interference reduction scheme, the processor further configured to determine the interference-reduction factor based in part on a sequence of pre-interference-reduction sample measurements and a sequence of post-interference-reduction sample measurements in accordance with the temporal interference reduction scheme.

34. The access network of claim 25, further comprising a memory embodying instructions executable by the processor.

35. The access network of claim 25, further comprising an interference-reduction unit, in communication with the processor.

36. The access network of claim 25, further comprising a Rake receiver in communication with the at least one receiver antenna and the processor.

37. An apparatus adapted for wireless communications, comprising:
means for determining a rise-over-thermal metric based on a rise-over-thermal received at each receiver antenna in a wireless communication system, the rise-over-thermal relating to a ratio of a total energy to a thermal energy received at each receiver antenna;
means for determining an interference-reduction factor in relation to an interference energy reduced from the total energy received at each receiver antenna; and
means for determining an effective rise-over-thermal based on the rise-over-thermal metric and the interference-reduction factor, the effective rise-over-thermal relating to an interference level in the wireless communication system.

38. The apparatus of claim 37, further comprising means for comparing the effective rise-over-thermal with a first threshold.

39. The apparatus of claim 38, further comprising means for relating a result of the comparison to each access terminal in the wireless communication system.

40. The apparatus of claim 39, further comprising means for setting a status for a reverse activity bit to be transmitted to each access terminal, the status being associated with the result of the comparison.

41. The apparatus of claim 38, wherein the means for comparing further determines a loading status associated with the wireless communication system, based on a result of the comparison.

42. The apparatus of claim 36, wherein the wireless communication system includes an access network, each receiver antenna being in communication with the access network.

43. A method for wireless communications, comprising:
determining a rise-over-thermal metric based on a rise-over-thermal received at each receiver antenna of an access network, the rise-over-thermal relating to a ratio of a total energy to a thermal energy received at each receiver antenna;
determining an interference-reduction factor in relation to an interference energy reduced from the total energy received at each receiver antenna; and
determining an effective rise-over-thermal based on the rise-over-thermal metric and the interference-reduction factor, the effective rise-over-thermal relating to an interference level in a wireless communication system.

44. The method of claim 43, further comprising comparing the effective rise-over-thermal with a first threshold and relating a result of the comparison to each access terminal in communication with the access network.

45. The method of claim 44 wherein the relating includes setting a corresponding status for a reverse activity bit to be transmitted to each access terminal.

46. The method of claim 44, further comprising comparing a maximum rise-over-thermal received at a particular receiver antenna of the access network with a second threshold, if the effective rise-over-thermal is less than the first threshold, and relating a result of the comparison to each access terminal in communication with the access network.
